(19) United States
(12) Patent Application Publication
(10) Pub. No.: US 2020/0216269 A1
(43) Pub. Date: Jul. 9, 2020

(54) MODULAR CONVEYOR BELT

(71) Applicant: Dale Holdings LTD, Cosmo City, Roodepoort (ZA)

(72) Inventor: Christopher Dale, Roodepoort (ZA)

(21) Appl. No.: 16/641,640

(22) PCT Filed: Aug. 24, 2018
(86) PCT No.: PCT/IB2018/056435

§ 371 Date: Feb. 27, 2020

(30) Foreign Application Priority Data
Aug. 24, 2017 (ZA) 2017/05763

(51) Int. Cl. B65G 17/08; B65G 21/18

(52) U.S. Cl. CPC B65G 17/08; B65G 15/30; B65G 21/18

(57) ABSTRACT

The invention relates to a driving end module of a modular conveyor belt, the driving end module having an elongate body with an arrangement of interspaced fingers on opposed sides along the length of the body. Each interspaced finger includes a transverse aperture which defines a link path through the transverse apertures into which a rigid rod can be inserted through an installation aperture to link two adjacent conveyor belt rows to each other and provide a conveyor belt section. The driving head also includes a socket located between the installation aperture and the link path which is shaped to receive a plug to prevent the rigid rod from sliding through the installation aperture. The driving end module further includes a terminal driving head having a positive drive protrusion which in use engages a vertically extending ridge of a rotating drive tower.

### CROSS REFERENCE TO RELATED APPLICATIONS INFORMATION

The present application is a U.S. national stage patent application, pursuant to 35 U.S.C. § 371, of PCT International Application No.: PCT/IB2018/056435, filed Aug. 24, 2018, published as WO 2019/038727 A1, which claims priority to South African provisional application No. 2017/05763, filed Aug. 24, 2017, the contents of all of which are hereby incorporated by reference in their entirety.

### FIELD OF THE INVENTION

This invention relates to conveyor belts. In particular, the invention relates to plastic modular conveyor belts, for use on a positive drive spiral conveyor system.

### BACKGROUND OF THE INVENTION

The inventor is aware of various types of plastic modular conveyor belts.

Modular conveyor belts are plastic conveyor belts made up of a plurality of module rows comprising of independent modules, the plurality of module rows are interconnected by transverse rods and are capable of straight or radius travels. Typically, these modular conveyor belts are used in spiral systems together with a driving tower. The driving tower has outward vertically extending bars which engage the ends of the rows on the conveyor belt.

In use, the transverse rod that keeps the rows connected to one another may slip out of the installation aperture thereby breaking the link between the two adjacent module rows.

Another drawback of current plastic modular conveyor belts is the fact that vertical movement can occur between the independent modules, this vertical movement between the modules can cause severe stress on the transverse rods and result in breaking.

Currently only plastic rods can be used in current plastic modular conveyor belts, because they are flexible enough to be inserted through an offset installation aperture into a link path of the conveyor belt modules.

The inventors identified various shortcoming in the current plastic modular conveyor belts and it is an objective of the present invention to address these shortcomings.

### SUMMARY

Broadly according to a first aspect of the invention there is provided a driving end module of a modular conveyor belt, which includes

an elongate body having

an arrangement of interspaced fingers on opposed sides along the length of the body, each interspaced finger includes a transverse aperture defining a link path through the transverse apertures;

a terminal driving head on one end of the elongate body;

an installation aperture provided on the terminal head, through which a rod is installable into the link path in use;

a socket provided on the terminal head, between the installation aperture and the link path; and

a plug shaped and dimensioned to be received into the socket, in use preventing the rod from sliding through the installation aperture.

The fingers of the driving end module may be in the form of projections extending transversely from the elongate body.

The terminal driving head may include a positive drive protrusion. In use the terminal driving head may be positioned on an operative inside of a conveyer belt section, such that the positive drive protrusion engages a vertically extending ridge of a rotating drive tower.

In one embodiment of the invention the positive drive protrusion may be bullet shaped.

The installation aperture may be located adjacent to the positive drive protrusion.

The installation aperture may be in line with the link path, such that a rigid rod is insertable through the installation aperture into the link path.

The plug may include a rod holding recess, in which an end of a rod is held in use.

The plug and socket may include a complementary securing formation, such that the plug is securable in the socket.

In one embodiment of the invention the plug and socket may include a complementary snap fit formation, such that the plug may be secured into the socket.

In another embodiment of the invention the plug and socket may include a complementary bayonet type formation, such that the plug may be secured and locked into the socket.

The plug may include an accessory extending upwardly therefrom. The accessory may be in the form of a sideplate, sideguard or the like.

The terminal driving head may include an engagement configuration having a male formation positioned on one side of the terminal head and a female formation on an opposed side of the terminal head. In use, when a conveyor belt section is assembled, the engagement formation is operable to engage with an adjacent conveyor belt end module, such that vertical movement between the conveyor belt end modules is restricted.

In one embodiment of the invention the engagement configuration may include a protruding formation which defines the male connector and a corresponding indentation which defines the female connector.

According to a second aspect of the invention, there is provided a conveyor belt construction kit which includes;

a plurality of conveyor belt modules each having a link path, the plurality of conveyor belt modules including at least one driving end module as described above, the conveyor belt modules arrangeable to construct at least a section of a conveyor belt; and

at least one rigid rod receivable in selected link paths, to link the conveyor belt modules to each other and provide a conveyor belt section.

The installation aperture located on the conveyor belt modules may be in line with the link path, to allow the rigid rod to be received into the link path via the installation aperture.

The rigid rod may be in the form of a steel rod.

The kit may further include one or more flexible rods. The flexible rods may be in the form of plastic rods.

According to a third aspect of the invention, there is provided a conveyer belt section, which includes

a preceding conveyor belt module row consisting of a plurality of interlinkable conveyer belt modules, including two end modules located at opposing ends of the row, one of the end modules being in the form of a driving end module as described, the conveyer belt row having an arrangement of interspaced fingers, each one of the interspaced fingers includes a transverse aperture defining a link path along the length of the row,

at least one succeeding module row corresponding to the preceding conveyor belt module row, positioned parallel adjacent to the preceding module row such that the arrangement of interspaced fingers of the preceding and succeeding module rows form an interdigitated configuration, the transverse apertures located in the arrangement of interspaced fingers provide an overlapped link path through the interdigitated configuration of the two adjacent module rows; and

a rod, receivable in the overlapped link path, to link the adjacent module rows and define the conveyer belt section.

The rod may be made of any one of the following materials: plastic, PVC, metal, steel or the like.

The conveyor belt section may include a plurality of succeeding conveyer belt module rows and rods. In such an embodiment the rods of the conveyor belt section may either all be of the same material, or the rods may be of an assortment of material. In one embodiment, most rods may be of plastic, with selected rods being of steel.

The modules may be made by any one of the following materials polyethylene, polypropylene, polytetrafluorethylene, polyvinylchloride, acrylics, condensation polymers or the like.

The modules may be manufactured by injection moulding, thermoforming, compression moulding, thermoset resin moulding, plastic foam molding, additive manufacturing or the like.

The invention will now be described by way of a non-limiting example only, with reference to the following drawing(s).

### DRAWINGS

In the drawings:

FIG. 1 shows a driving end module of a modular conveyor belt for use on an operative inside of a conveyor belt section in accordance with one aspect of the invention;

FIG. 2 shows an engagement formation in use between two adjacent driving end modules;

FIG. 3 shows a plan view of a conveyor belt section comprising a plurality of conveyor belt module rows;

FIG. 4 shows a three-dimensional view of a conveyor belt section comprising a plurality of conveyor belt module rows;

FIG. 5 shows an end module of a modular conveyor belt for use on an operative outside of a conveyor belt section;

FIG. 6 shows a side view of a sideguard accessory for use with the end module of FIG. 1;

FIG. 7 shows a three-dimensional view of the sideguard accessory as seen in FIG. 6; and

FIG. 8 shows a three-dimensional view of the sideguard accessory for use with the end module of FIG. 5.

### EMBODIMENTS OF THE INVENTION

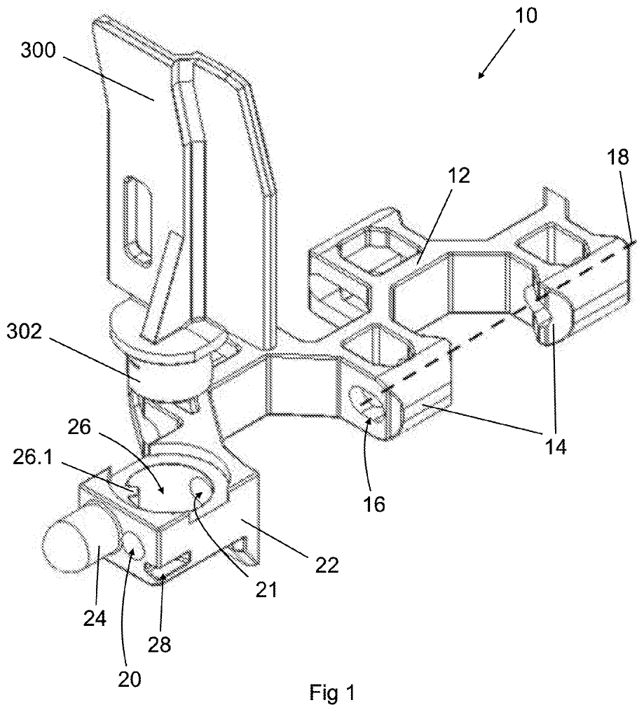

In FIG. 1 a driving end module (10) for use on an operative inside of a modular conveyer belt row is shown. The conveyor belt is constructed from a plurality of plastic conveyor belt modules and includes positive drive protrusions on an inside of the belt, for use in a positive drive spiral conveyor system. The end module (10) comprises an elongate body (12) having an interspaced finger arrangement (14) extending from opposing sides along the length of the body (12), each of the interspaced fingers (14) includes a transverse aperture (16) which defines a link path (18) through the apertures.

The link path (18) is in the form of a longitudinal passage along the length of the elongate body (12).

The driving end module (10) also includes a terminal driving head (22) on one end of the elongate body (12). The terminal driving head (22) includes a bullet shaped positive drive protrusion (24), in use the positive drive protrusion (24) is operable to engage vertically extending protruding ridges (not shown) of a central rotating drive tower (not shown).

The driving end module (10) further includes an installation aperture (20) provided on the terminal head (22). The installation aperture (20) is located adjacent to the positive drive protrusion (24). The terminal head (22) also has a second aperture (21), in line with the link path (18), between the installation aperture (20) and the link path (18). The installation aperture (20) is positioned in line with link path (18), such that a rigid rod is installable into the link path (18) via the installation aperture (20).

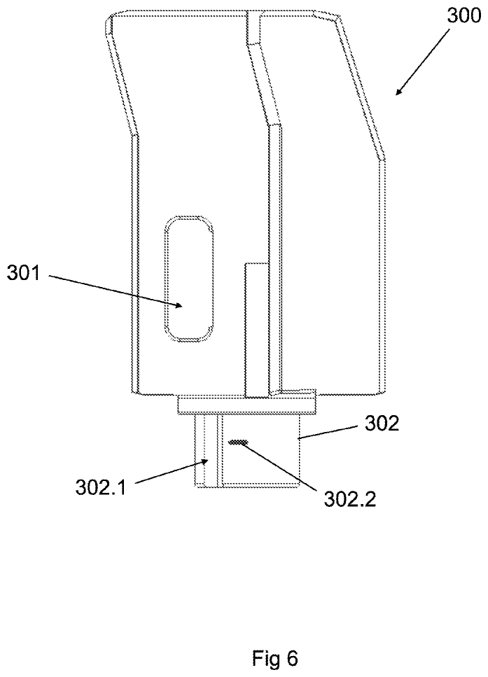

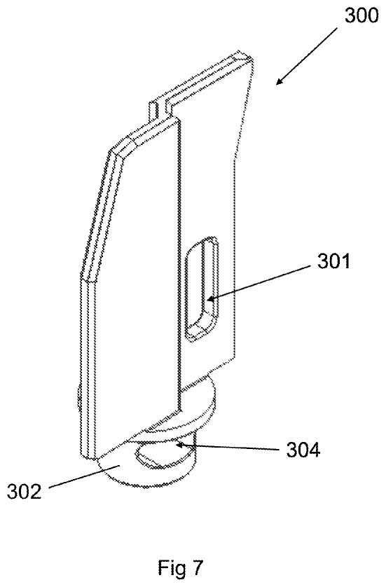

The terminal driving head (22) further includes a socket (26) sized to mate with a plug (302) of an accessory (see FIGS. 6 and 7). The socket (26) and plug (302) having complementary guiding formation in the form of a guiding ridge (26.1) located on the socket (26) and a guiding slot (302.1) located in the plug (302). The socket (26) is provided between the installation aperture (20) and the link path (18). The plug (302, see FIG. 6) of the accessory (300) includes a rod holding recess which is in the form of a semicircular cavity (304) formed to receive and prevent the rigid rod from sliding through the installation aperture (20).

Thus, in use the driving end module (10) is arranged with other conveyor belt modules to provide a conveyor belt. A rigid rod is then inserted through the installation aperture (20) into the link path (18) to connect the conveyor belt modules, and the plug (302) is inserted into the socket (26) on the terminal head (22), such that the rigid rod is retained in the link path (18).

The terminal head (22) includes an engagement configuration located on opposed sides of the terminal head (22). The engagement configuration includes a protruding formation (30) which defines the male connector and a corresponding indention which defines the female connector (28).

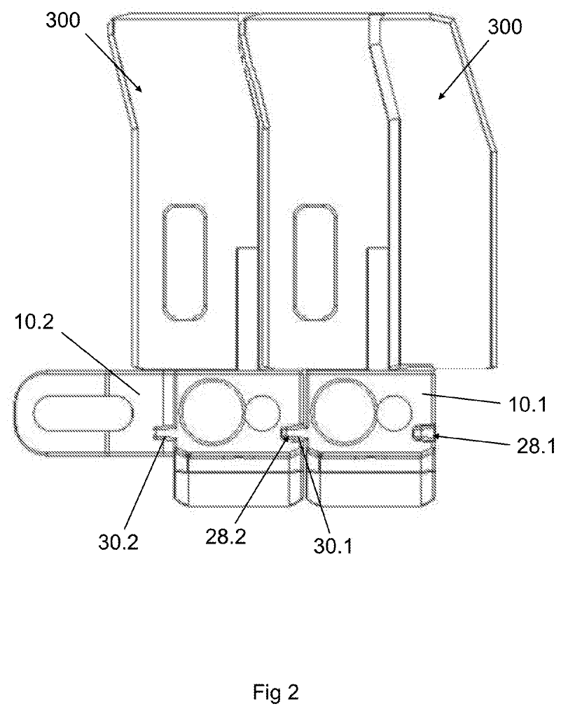

Referring to FIG. 2, two adjacent conveyor belt end modules (10.1) (10.2) is shown. The male formation (30.1) of the one end module (10.1) is operable to engage the female formation (28.2) of the other end module (10.2), such that vertical movement between the adjacent conveyor belt end modules (10.1, 10.2) is restricted.

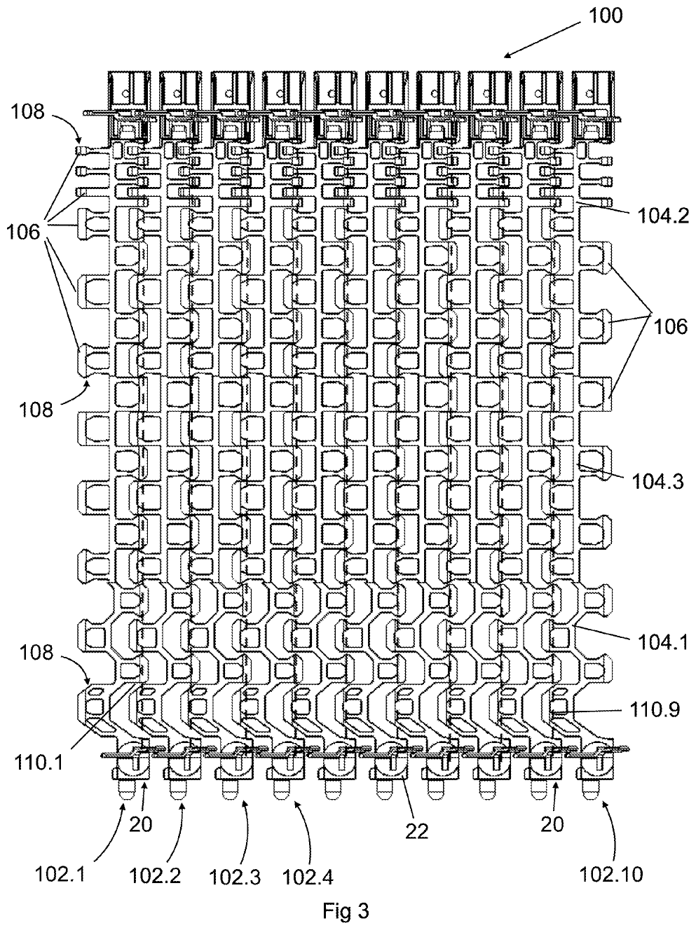

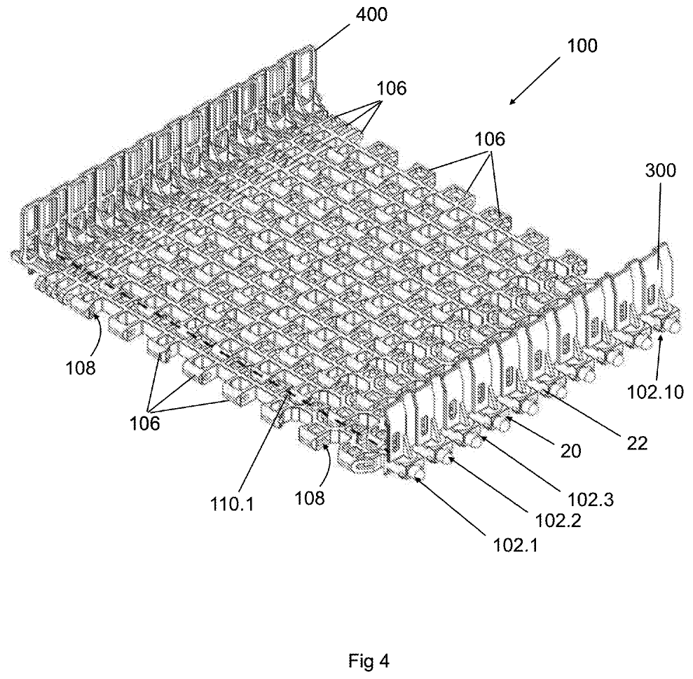

In FIG. 3 and FIG. 4 a conveyor belt section (100) is shown. The conveyor belt section (100) includes a preceding conveyor belt module row (102.1) and a plurality of succeeding conveyor belt module rows (102.2-102.10).

In this example one of the conveyor belt module rows (102.1-102.10) consist of a plurality of interlinkable modules (104), including two end modules (104.1) (104.2) located at opposing ends of a central module (104.3). It is to be appreciated that a conveyor belt module row can consist of any number of interlinkable modules. The conveyor belt module rows (102) have a plurality of interspaced fingers (106), each one having a transverse aperture (108). The interspaced fingers (106) defining an interspaced finger arrangement along the length of the conveyor belt row.

The interlinkable modules of the subsequent (102.2-102.10) module rows are positioned parallel adjacent to the preceding module row (102.1-102.9) and are configured to form an interdigitated configuration between the adjacent rows (102). The transverse apertures (108), which are located in the interspaced fingers (106), define an overlapped link path (110) through the interdigitated configuration of the adjacent module rows (102) into which the rigid rod (not shown) is receivable via the installation aperture (20) to link adjacent rows (102) and define the conveyer belt section (100).

The driving end modules (104.1) all include positive drive protrusions (24) located on the terminal heads (22), in use the positive drive protrusion (24) operable to engage vertically extending protruding ridges (not shown) of a central rotating drive tower (not shown) and have socket openings operable to receive and secure a plug with an accessory (see FIG. 6 and FIG. 7). Rods are inserted into each overlapped link path (110.1-110.9) through the installation aperture (20), with no need to bend the rods, due to the installation aperture (20) being in line with the link path. The plugs (302, see FIG. 6 and FIG. 7) are then inserted into the sockets to secure the rods in the link paths (110.1-110.9) and prevent the rods from sliding through the installation aperture (20).

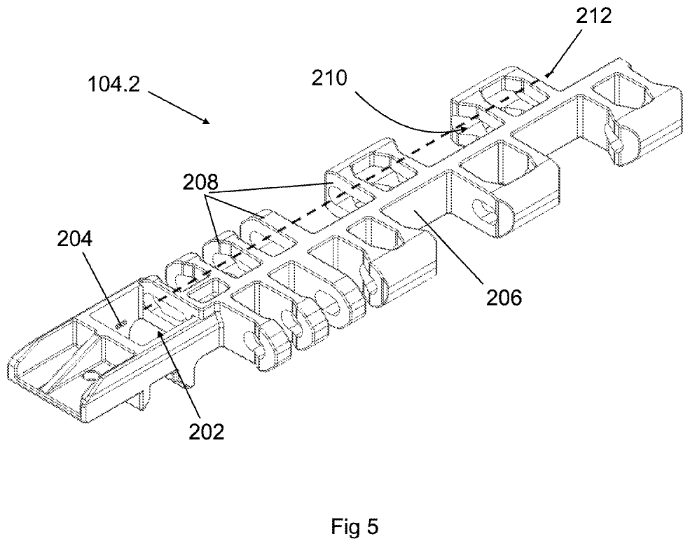

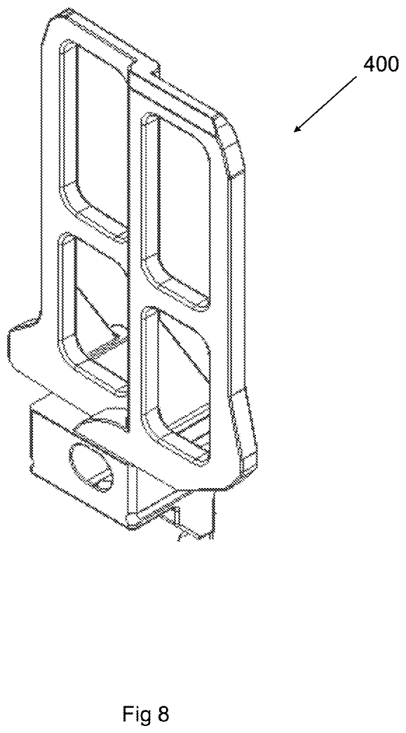

In FIG. 5 reference numeral (104.2) shows the end module of FIG. 3 and FIG. 4 for use on an operative outside of a conveyer belt section in more detail. The end module (104.1) includes a socket (202) having protruding ridges (204) located on opposing sides, the ridges defining a complementary snap fit formation securing an accessory (see FIG. 8) once inserted to the end module. The end module (200) comprises an elongate body (206) having an interspaced finger arrangement (208) extending from opposing sides along the length of the body (206), each of the interspaced fingers (208) includes a transverse aperture (210) which defines a link path (212) through the apertures.

FIG. 6 and FIG. 7 shows detailed views of the plug and accessory of the driving end module of FIG. 1. Reference numeral (300) denotes a sideguard accessory having an aperture (301) to control airflow. The sideguard accessory includes a guiding formation in the form a guiding slot (302.1) and a clip formation (302.2) which secures the sideguard accessory to the socket (26) of the end module (104.1) located at the operative inside of the conveyor belt section. The plug (302) of the sideguard includes a rod holding recess in the form of a semicircular cavity (304) which in use will prevent the rod from sliding through the installation aperture when the end module is in use.

Referring to FIG. 8 a detailed view of the accessory (400) of the end module for use on an operative outside is shown. The accessory (400) is receivable by the socket (202) of the end module located at the operative outside of the conveyor belt section.

Currently in modular plastic conveyor belts, the installation aperture is offset from the link path. A plastic rod is therefore used which can be bent through the installation aperture into the link path and once completely inserted the rod shifts inside the terminal head such that it is not in line with the installation aperture. These current system does not allow for rigid rods to be used, as the rod cannot be bent through the offset installation aperture into the link path. Therefore, to allow a rigid rod to be inserted into the link path the installation aperture must be in line with the link path, this however creates the possibility that the rod will slide through the installation aperture during use, thereby causing the belt section to break apart. The accessories of the current invention include a plug with a rod holding recess to prevent the rod from sliding through the in-line installation aperture once the accessory is secured in the socket of the end module. This allows that a combination of rigid and plastic rods can be used with the current invention.

The inventor believes that the invention provides a new modular conveyor belt which allows steel rods to easily be inserted to connect adjacent modular rows and prevents the rods from slipping out during use of the conveyor belt.

1.-32. (canceled)

33. A driving end module of a modular conveyor belt, the driving end module comprising:
an elongate body having
an arrangement of interspaced fingers on opposed sides along the length of the body, each interspaced finger includes a transverse aperture defining a link path through the transverse apertures;
a terminal driving head on one end of the elongate body, the terminal driving head includes a positive drive protrusion, in use the terminal driving head is positioned on an operative inside of a conveyer belt section, such that the positive drive protrusion engages a vertically extending ridge of a rotating drive tower;
an installation aperture provided adjacent to the positive drive protrusion on the terminal head, through which a rod is installable into the link path in use;
a socket provided on the terminal head, between the installation aperture and the link path; and
a plug shaped and dimensioned to be received into the socket, in use preventing the rod from sliding through the installation aperture.

34. The driving end module of claim 33, wherein the fingers are in the form of projections extending transversely from the elongate body.

35. The driving end module of claim 33, wherein the positive drive protrusion is bullet shaped.

36. The driving end module of claim 33, wherein the installation aperture is in line with the link path, such that a rigid rod is insertable through the installation aperture into the link path.

37. The driving end module of claim 33, wherein the plug includes a rod holding recess, in which an end of the rod is held in use.

38. The driving end module of claim 33, wherein the plug and socket includes a complementary securing formation, such that the plug is securable in the socket.

39. The driving end module of claim 38, wherein the complementary securing formation is in the form of a snap-lock formation.

40. The driving end module of claim 38, wherein the complementary securing formation is in the form of a bayonet type formation, such that the plug can be secured and locked into the socket.

41. The driving end module of claim 33, wherein the plug includes an accessory extending upwardly therefrom.

42. The driving end module of claim 41, wherein the accessory is in the form of a side plate.

43. The driving end module of claim 41, wherein the accessory is in the form of a sideguard.

44. The driving end module of claim 33, wherein the terminal driving head includes an engagement configuration having a male formation positioned on one side of the terminal head and a female formation on an opposed side of the terminal head, in use, when a conveyor belt section is assembled, the engagement formation is operable to engage with an adjacent conveyor belt end module, such that vertical movement between the conveyor belt end modules is restricted.

45. The driving end module of claim 44, wherein the engagement configuration includes a protruding formation which defines the male formation and a corresponding indentation which defines the female formation.

46. A conveyor belt construction kit, comprising:
a plurality of conveyor belt modules each having a link path, the plurality of conveyor belt modules including at least one driving end module as claimed in claim 33, the conveyor belt modules arrangeable to construct at least a section of a conveyor belt; and
at least one rigid rod receivable in selected link paths, to link conveyor belt modules to each other and provide a conveyer belt section.

47. The conveyor belt construction kit of claim 46, in which the at least one rigid rod is in the form of a steel rod.

48. A conveyer belt section, comprising:
a preceding conveyor belt module row consisting of a plurality of interlinkable conveyer belt modules, including two end modules located at opposing ends of the row, one of the end modules being in the form of a driving end module as claimed in claim 33, the conveyer belt row having an arrangement of interspaced fingers, each one of the interspaced fingers includes a transverse aperture defining a link path along the length of the row;
at least one succeeding module row corresponding to the preceding conveyor belt module row, positioned parallel adjacent to the preceding module row such that the arrangement of interspaced fingers of the preceding and succeeding module rows form an interdigitated configuration, the transverse apertures located in the arrangement of interspaced fingers provide an overlapped link path through the interdigitated configuration of the two adjacent module rows; and
a rod, receivable in the overlapped link path, to link the adjacent module rows and define the conveyer belt section.

49. The conveyor belt section of claim 48, wherein the conveyor belt section includes a plurality of conveyer belt module rows and rods.

50. The conveyor belt section of claim 49, wherein a plurality of rods are made of any one or a selection of the following materials: plastic, PVC, metal and steel.

51. The conveyor belt section of claim 50, wherein a majority of rods are of plastic, with selected rods being of steel.

52. The conveyor belt section of claim 48, wherein the end modules located at opposed ends of each row to the driving end modules, include hold down formations, which are positioned on an operative outside of the conveyer belt section.
